(19) United States
(12) Patent Application Publication
(10) Pub. No.: US 2005/0139040 A1
(43) Pub. Date: Jun. 30, 2005

(54) Champagne bottle opener

(76) Inventor: Cleveland Benedict Crudgington JR., Monrovia, CA (US)

Correspondence Address: Cleve B. Crudgington, Jr., 222 N. Myrtle Avenue, Monrovia, CA, 91016, US

(21) Appl. No.: 10/746,780

(22) Filed: Dec. 29, 2003

(51) Int. Cl. B67B 7/16

(52) U.S. Cl. 81/3.55

(57) ABSTRACT

The Champagne Bottle Opener, a hand manipulable device is described for removing mushroom-shaped stoppers from sparkling beverage bottles. It includes a pair of bifurcated jaws and opposing handles about a common pivot wherein each jaw contains improvements over prior art, improvements that enable the device to function more effectively for the wide dimensional variances in bottle and cork diameters commonly found in the marketplace. The opposing handles contain improvements as well permitting the device to be operated more easily and safely. Also included in the present invention are features that generate a tactile “snap” when the device is properly inserted about the bottle, and provide improved means for anchoring the tool when engaging in the extraction of any mushroom-shaped stopper.

### U.S. PATENT DOCUMENTS

| | | | |
|---|---|---|---|
| 2,761,338 | September 1956 | Hardy | 81/3.38 R |
| 3,722,327 | March 1973 | Strassel | 81/3.36 R |
| 3,800,345 | April 1974 | Feliz | 7/14.6 |
| 4,018,110 | April 1977 | Spriggs | 81/3.08 |
| 4,387,609 | June 1983 | Poisfuss | 81/3.36 |
| 4,422,355 | December 1983 | Burns | 81/3.46 |
| 4,606,245 | August 1986 | Veverka | 81/3.36 |
| 4,875,394 | October 1989 | Crudgington | 81/3.08 |
| 4,947,711 | August 1990 | Glebeler | 81/3.37 |
| 5,275,070 | January 1994 | St. Denis | 81/3.29 |
| 5,347,889 | September 1994 | St. Denis | 81/3.29 |
| 5,868,044 | February 1999 | Sonderman | 81/3.29 |

### FOREIGN PATENT DOCUMENTS

| | | | |
|---|---|---|---|
| 53681 | September 1937 | Denmark | 81/417 |
| 25798 | February 1953 | Finland | 81/3.09 |

### BACKGROUND OF THE INVENTION

1. Field of the Invention

The present invention applies to specific improvements to bottle stopper removers for removing mushroom-shaped stoppers, those commonly made from either cork or plastic, from champagne and other sparkling beverage bottles, and more specifically applies to extractors that incorporate opposing bifurcated jaws and a pair of handles about a common pivot; jaws that provide a leveraged lifting action for removing the stopper by squeezing said handles.

2. Description of Related Art

Invention and use of bottle stopper removers for sparkling beverages sealed with mushroom-shaped stoppers are known to the public. The concept of using bifurcated jaws for such devices was first introduced by Spriggs, U.S. Pat. No. 4,018,110. While the concepts disclosed by Spriggs are valid, significant refinements brought forth in Crudgington U.S. Pat. No. 4,875,394 were necessary to produce a viable product of this type.

This type of bottle stopper remover in its basic form is comprised of upper and lower bifurcated jaws that engage about the neck or top of the bottle. Each jaw forms a pair of prongs with essentially a U-shaped blade incorporated therein. Depending on its application the blade associated with the lower jaw rests directly on either the flared section directly below the bottle's lip or on the top of the bottle's lip, while the blade belonging to the upper jaw is positioned under the head of either a cork or plastic stopper. A squeeze of a pair of handles about a common pivot results in the spreading of the jaws which in turn serves to exert an upwardly-directed leveraged force on the stopper, thus eliminating the need to manually “wrestle” the stopper out of the bottle.

3. Object of the Invention

It is the object of the present invention to provide significant improvements to inventions previously disclosed by Spriggs and Crudgington that enhance the function of hand manipulable devices of this type for removing mushroom shaped stoppers from sparkling beverage bottles.

### SUMMARY OF THE INVENTION

The present invention focuses particularly on certain improvements in such pullers hereafter referred as the champagne bottle opener, or simply the opener, puller or extractor. Prior art neglects to address problems arising from the wide dimensional variances found in sparkling beverage bottles and stoppers contained therein. Of greatest concern is the variation in diameter of the lip at the top of the bottle and the diameter of the stopper, particularly those made of natural cork The lip of sparkling wine bottles will vary in diameter from about 1.04″ to 1.15″ and the size of cork stoppers varies even more; in some cases the cork's head is only slightly larger than the bottle's lip. If the problems associated with these dimensional variances is not adequately addressed, the opener of the bifurcated jaw type may fail to function properly: if too large the upper jaw may inadvertently slip over a small cork stopper without lifting it; or if too small, the opener may break or worse yet, chip shards of glass from the bottle's lip while attempting to slide over the lip. For an opener to be reliable over the broadest range of bottle and cork configurations, the problems arising from dimensional variances are examined and improvements are set forth. The full implication of these size variations will be detailed along with advancements in the current invention that address the corresponding issues.

Introduced in my invention are significant refinements in the upper and lower bifurcated jaws that improve stopper retaining means, stopper gripping means and bottle anchoring means, along with identifying the importance of the material used to obtain desired mechanical characteristics. Prior art neglects to introduce the advantages of an opener that provides the means to inform the user that the tool has been fully and properly positioned for extracting a stopper, this being another object of my invention. Additionally, inherent problems, with spring clip mechanisms introduced in prior art for retaining or holding a stopper during extraction, are detailed herein. An improvement set forth eliminates the need for using spring clip(s) or other means to grab or clamp the stopper, yet prevents the released stopper from inadvertently ricocheting out of the puller's stopper-retaining device during extraction.

The wish-bone shaped handle configuration depicted in prior art for bifurcated stopper extractors is replaced with an improved design that is fully set forth. The problems inherent in this configuration are addressed, with embodiments that enhance the manipulation of the opener without sacrificing leverage capability or vertical lift.

### BRIEF DESCRIPTION OF THE DRAWINGS

FIG. 1 is a perspective view of the assembled Champagne Opener consisting of an upper lever, lower lever, a pair of hinge pins that snap together and an internal hinge spring not shown. Also illustrated are the two types of mushroom-shaped stoppers, a typical one made of cork and the other a typical one made of plastic.

FIGS. 2 & 2a are perspective views of the opener assembly and the lower lever positioned for extraction of all mushroom-shaped plastic stoppers from a typical sparkling beverage bottle.

FIGS. 3 & 3a are perspective views of the opener assembly and the lower lever positioned for removal of a cork stopper sealing an unusually large-lipped sparkling beverage bottle.

FIGS. 4 & 4a are perspective views of the opener assembly and the lower lever positioned for removal of cork stoppers sealing all normal sized sparkling beverage bottles.

FIG. 5 is a perspective view of the upper lever showing preferred embodiments of the upper jaw and associated elements.

FIG. 6 is a top perspective view of the upper jaw detailing preferred embodiments of the blade configuration.

FIG. 7 is a bottom orthographic view of the upper jaw detailing preferred embodiments of the blade configuration and the stopper retaining means.

FIG. 8 is a front orthographic view of the upper jaw positioned for extraction of all plastic stoppers.

FIG. 8a is a side orthographic section view of FIG. 8 primarily illustrating the relationship between plastic stopper and stopper retaining means.

FIG. 9 is a front orthographic view of the upper jaw positioned for extraction of a cork stopper sealing an unusually large-lipped sparkling beverage bottle.

FIG. 9a is a side orthographic section view of FIG. 9 primarily illustrating the relationship between cork stopper and stopper retaining means.

FIG. 10 is a perspective view of the lower lever showing preferred embodiments of the lower jaw and associated elements.

FIG. 11 is a bottom orthographic view of the lower jaw showing preferred embodiments of the lower jaw.

FIG. 12 is a front orthographic section view of FIG. 4 detailing embodiments of the upper and lower blade configuration when applied to a mushroom-shaped cork stopper sealed to a normal sized sparkling beverage bottle.

FIG. 13 is a side view of the opener assembly with the upper and lower levers in the “relaxed” position illustrating preferred embodiments to the handle configuration and the stopper retaining means.

FIG. 14 is a side view of the opener assembly with the upper and lower levers in the fully squeezed position illustrating preferred embodiments to the handle configuration and the stopper retaining means.

### DESCRIPTION OF PREFERRED EMBODIMENTS

The basic elements comprising a bifurcated stopper puller are not new to the art as they were introduced and described in prior art. The present invention introduces numerous and significant improvements to all such pullers. Whereas the preferred configuration of the improvements relating to the invention has been illustrated and described herein, it should be realized that the embodiments are to be considered in all respects illustrative and not restrictive.

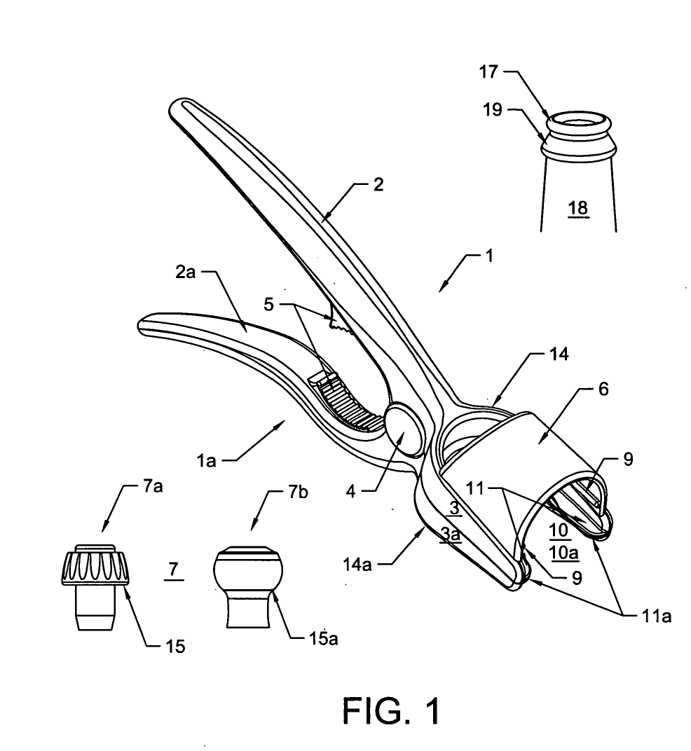

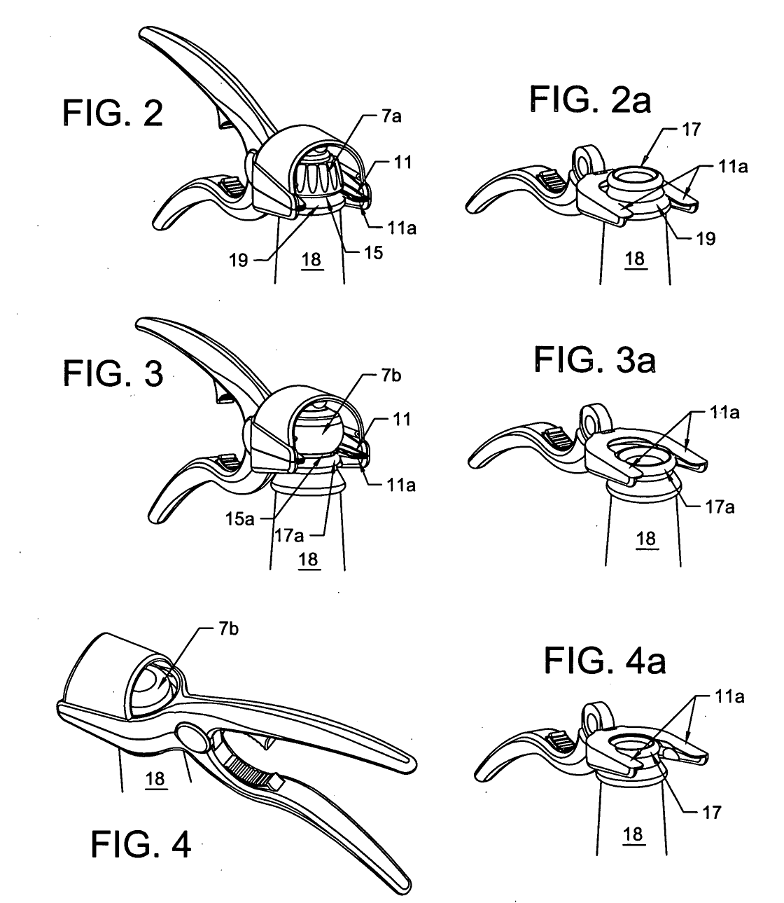

The bifurcated stopper puller illustrated in FIG. 1 is comprised of a pair of levers, upper 1 and lower 1a, which at one end form a pair of handles, upper 2 and lower 2a, and at the opposite end a pair of bifurcated jaws, upper 3 and lower 3a. The levers 1 and 1a are joined by a pivot pin assembly 4, so that the squeezing together of the handles 2 and 2a causes the opening of upper 3 and lower 3a jaws. Typically, a spring (not shown) is placed between the handles 2 and 2a for returning the levers 1 and 1a to their original rest position, making the puller easier to hold during placement. Additionally, stopper gripping means 5 is positioned between the handles 2 and 2a for conventional cork removal by gripping and rotating the stopper. A stopper retaining member 6 is affixed to the upperjaw 3. Bifurcated jaws, upper 3 and lower 3a each have a pair of ridges 14 and 14a formed around their perimeters for reinforcement. The interior of upper 3 and lower 3a jaws contain upper blade 11 and lower blade 11a respectively, each of which forms a generally “U” shaped upper recess 10 and lower recess 10a. Upper recess 10 provides the means for addressing either a mushroom-shaped plastic stopper 7a below its base 15, or mushroom-shaped cork stopper 7b at it's downwardly presented shoulder 15a; and the lower recess 10a provides the means for anchoring to either the lip 17 or shoulder 19 of a sparkling wine or similar beverage bottle 18 sealed with either plastic stopper 7a or cork stopper 7b. Henceforth, any reference that refers to both plastic stopper 7a and cork stopper 7b, will be referred to simply as stopper 7. To accommodate the wide variety of bottle-stopper configurations three positions for placing the opener around the bottle 18 are available as illustrated in FIGS. 2, 3 & 4, wherein each position addresses different stopper 7 and bottle 18 configurations. As shown in FIGS. 2 & 2a, the opener rests on shoulder 19 of bottle 18, that being the proper anchoring position for removing all plastic stoppers 7a. As seen in FIGS. 3 & 3a, the opener rests on top of the bottle's lip 17a having unusually large internal and external diameters as is the case with certain European brands. FIGS. 4 & 4a illustrate the third manner of inserting the opener for most cork stopper 7b and bottle 18 configurations, where the opener is sized to rest on top of the typical bottle's lip 17 and to slip around the base of a typical cork stopper's head 15a.

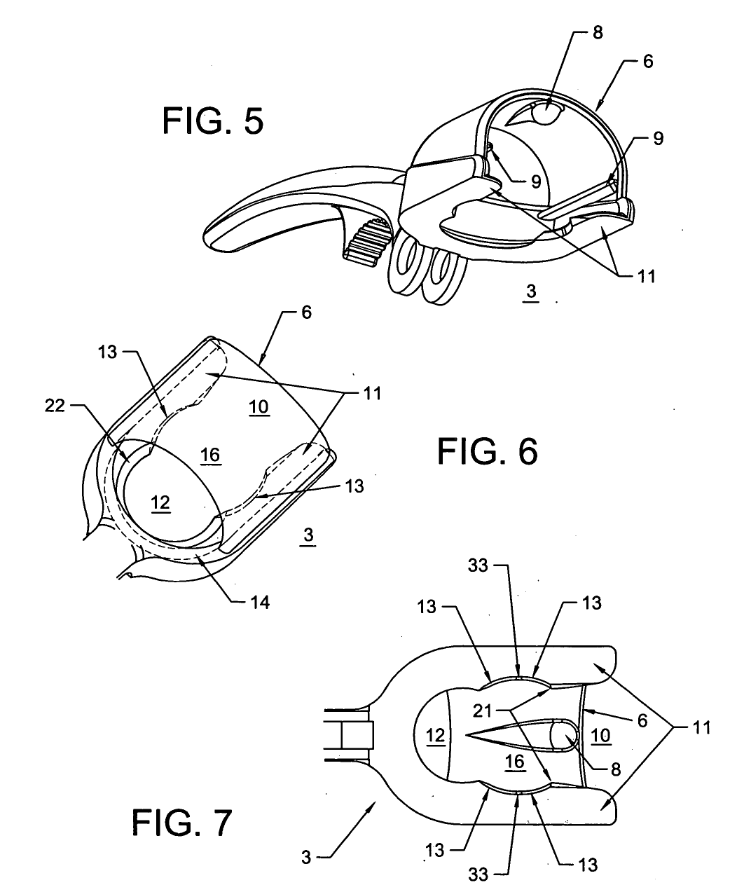

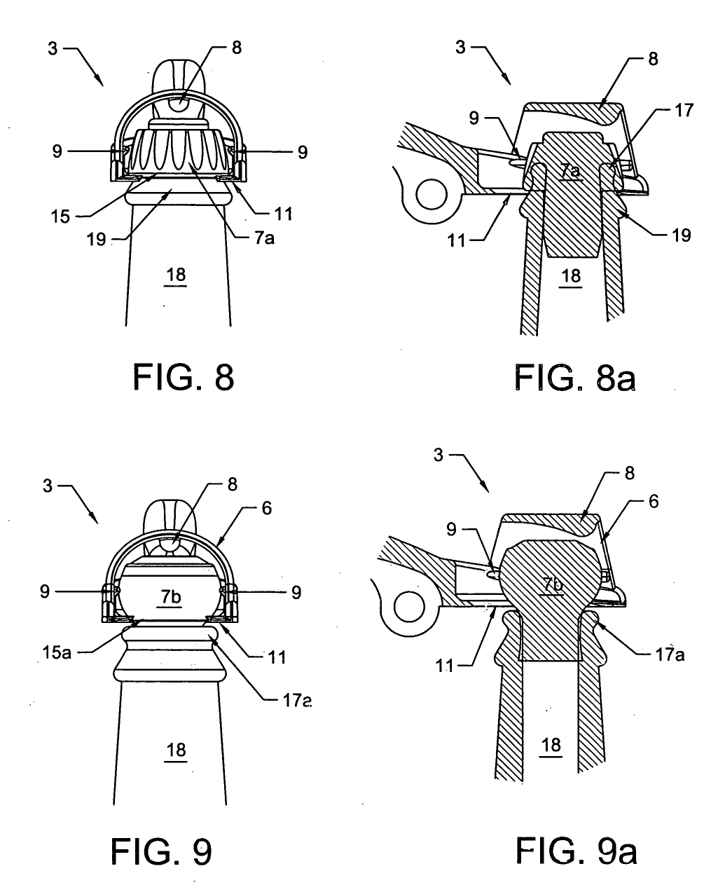

FIGS. 5, 6, 7, 8, 8a, 9 & 9a show the upper jaw 3 configuration in various views, with FIGS. 8 & 8a illustrating the application with a typical plastic stopper 7a and sparkling beverage bottle 18; and FIGS. 9 & 9a showing one of two possible positions to engage a cork stopper 7b, in this case one sealing a sparkling beverage bottle 18 with an unusually large lip 17a. In order to prevent any stopper 7 from inadvertently ricocheting out from under the stopper retaining member 6, prior art introduced the use of a spring loaded stopper retaining member or a stopper retaining member with one or more spring loaded clips. Experience has shown that the use of a spring loaded mechanism to grip the stopper 7 has several inherent problems: springs tend to weaken over time, making them less reliable; the force that springs apply for gripping purposes tends to work against the insertion of the opener; and the wide size range of cork stoppers 7b results in the spring clip mechanism becoming ineffective for unusually large or small stoppers 7b. Spring clip(s) are found to be either too loose for small-headed corks or too tight for large-headed corks. Even in those cases where properly sized, spring clip(s) tend to impede the insertion of the opener around the stopper because the clip(s) exert a counter force while engaging about the stopper's head. The result is an increased difficulty in positioning the tool for insertion about the stopper 7, or increased difficulty in inserting the opener into the proper position for extraction. In the present invention, the stopper retaining member 6, either attached to or made part of the upper jaw 3, includes a refinement that eliminates the need to grip the stopper 7 in order to prevent its accidental ejection from the opener. Rather than proving means to grip the stopper 7, a stopper deflecting means 8 is centered within the stopper retaining member 6, and is positioned and beveled in such a manner as to deflect the released stopper 7 towards the rear of the upper jaw 3 where it is safely contained within the retaining member 6. This deflecting means 8 can best be understood in FIGS. 8a & 9a. Since the deflecting means 8 is not required to make contact with the pre-extracted stopper 7 in order to be effective, the stopper retaining member 6 along with deflecting means 8 can be sized to accommodate even the larger cork stoppers 7b without sacrificing its effectiveness with smaller stoppers 7.

Another significant improvement set forth is the addition of a pair of rails 9 on both sides and within the interior of stopper retaining member 6, most clearly visible in FIG. 5. As can be visualized from viewing FIGS. 8 & 9, the pair of rails 9 helps guide the insertion of the opener around any stopper 7. FIGS. 8a & 9a show how the rails 9 are positioned above and primarily parallel to upper blade 11. The pair of rails 9 can be effectively spaced apart so that they make contact with most plastic stoppers since the dimensional variance of plastic stoppers 7a is nominal. Furthermore, a common element of all plastic stoppers 7a is that the widest portion is at the base of the head 15, thereby permitting the base of the head 15 to rest underneath rails 9 as illustrated in FIG. 8. Thus, pair of rails 9 provides the means to impede the upward motion of a released plastic stopper 7a and assist in discarding it from the opener by preventing the dislodged plastic stopper 7a from lifting up and catching on the beveled protrusion 8 as it is being pushed out of the opener.

As evident in FIGS. 5, 6 & 7, the stopper gripping means of blade 11 within upper jaw 3 has been enhanced by introducing a pair of opposing curvatures 13 within the generally “U” shaped recess 10 described in prior art. When these curvatures 13 are viewed together as illustrated in FIG. 6, the pair of curvatures 13 form a primarily circular slot 16, thereby increasing the possible surface contact between blade 11 and any stopper 7 when the opener is positioned as shown in FIG. 2 or 3. In both positions, the pair of curvatures 13 are aligned with and conform to the circular shape of all type stoppers 7 so that with plastic stoppers 7a as shown in FIG. 2, increased surface contact is made between blade 11 and the base of the plastic stopper head 15; or with cork stoppers 7b as shown in FIG. 3, increased surface contact is made between blade 11 and the downwardly presenting portion of a cork stopper's head 15a. Also included within the upper jaw 3 as seen in FIG. 6 is a secondary generally circular recess 12 positioned at the base of primary recess 10 for positioning the opener as seen in FIG. 4. And while recess 12 was disclosed in prior art, it is made significantly more effective by introducing an upwardly facing chamfer 22 seen most clearly in FIG. 6 so that recess 12 is wider at the top of blade 11 than at the bottom and having a cross-sectional width sufficient to permit the opener to pass under and around the base of a cork stopper 7b. By introducing chamfer 22 to recess 12, engagement between blade 11 and downwardly facing shoulder 15a is improved thereby eliminating the requirement to engage about a partially lifted the stopper 7b as defined in prior art. Recess 12 is further enhanced by increasing its curvature past 180° as shown in FIG. 7 so that blade 11 slightly encircles the cork stopper 7b, thus providing the means to generate a slight locking action when the opener is positioned for extraction.

As viewed in FIG. 7 a further innovation within the upper jaw 3 is the slight tapering of blade 11 at the entrance of upper recess 10 where the width of the upper recess 10 narrows from the entrance with the narrowest point 21 being at the front of opposing curvatures 13. By making the upper jaw 3 and/or blade 11 from a rigid material with some degree of flexibility, as with certain plastics, the narrowest point of blade separation 21 can be made to spread apart slightly during insertion. The primary recess 10 in upper blade 11 at its narrowest point 21 can thereby be appreciably less than the diameter of bottle 18 where applied, that being directly under the head of plastic cork 7a as seen in FIG. 2, or appreciably less than the diameter at the base 15a of cork stopper 7b as seen in FIG. 3. This embodiment enhances the gripping means of blade 11 by further encompassing either type stopper 7 thereby increasing contact through the extended arc length of curvatures 13. Furthermore, the momentary splaying action of blade 11 during insertion of the opener creates a spring-loaded force that assists the user in properly positioning the opener by centering either bottle 18 as shown in FIG. 8, or cork stopper 7b as shown in FIG. 9, within the circular slot 16 as blade 11 returns from its flexed to normal shape. In addition, the momentary splaying of blade 11 generates a slight snapping action that can be felt, thereby informing the user that the puller has been fully and properly inserted.

FIGS. 8 & 8a illustrate a typical sparkling beverage bottle 18 sealed with a plastic stopper 7a. When the opener is positioned for extraction, the circular slot 16 within upper blade 11 shown in FIGS. 6 & 7 is centered about the bottle 18. Normally, all plastic stoppers 7a cover the bottle's lip as shown in FIGS. 2 & 2a necessitating that upper blade 11 pass over lip 17 during removal of a plastic stopper 7a. For most domestic sparkling beverage bottles, the diameter of circular slot 16 is sized to be larger than lip 17 thereby providing adequate clearance for upper blade 11 to pass over bottle lip 17 during extraction. As seen in FIG. 7, to remove a plastic stopper 7a sealing a sparkling beverage bottle with the largest diameter lip 17, curvatures 13 have been modified to accommodate a larger diameter lip 17. On each side of blade 11 curvature 13 has been elongated by splitting each curve into two nearly identical curvatures 13 whose radii are bisected by a slight separation 33 thereby forming two pair of adjacent curvatures 13 as seen in FIG. 7. The separation 33 between curvatures 13 enables upper blade 11 to slide over a bottle lip 17 having a diameter greater than that of curvatures 13, without necessitating the increase of the cross-sectional width of circular slot 16. By manufacturing the upper jaw 3 and/or upper blade 11 from a rigid material with some degree of flexibility, as with certain plastics, blade 11 can be made to spread apart sufficiently during the extraction of any plastic stopper 7a. By this means circular slot 16 remains sufficiently small for blade 11 to make the best possible contact with the underside 15 of a plastic stopper 7a or the downwardly presenting shoulder 15a of a cork stopper 7b.

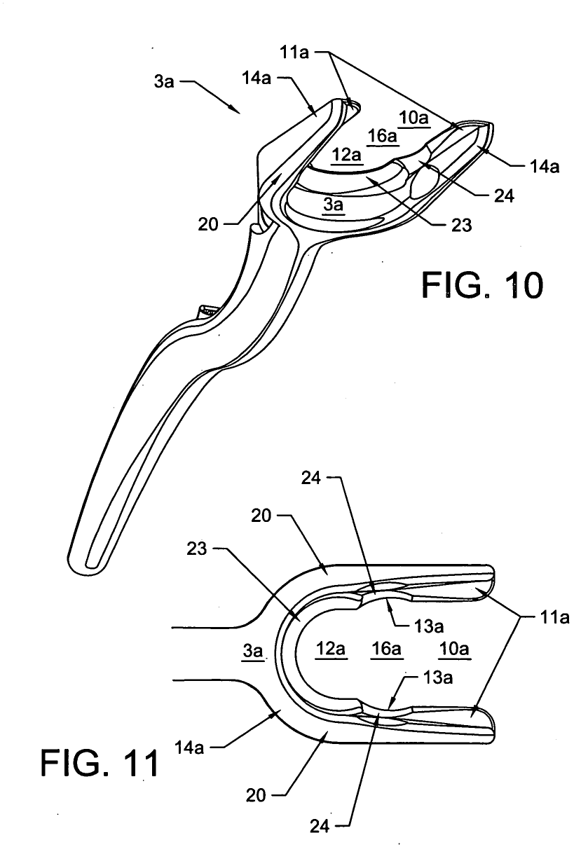

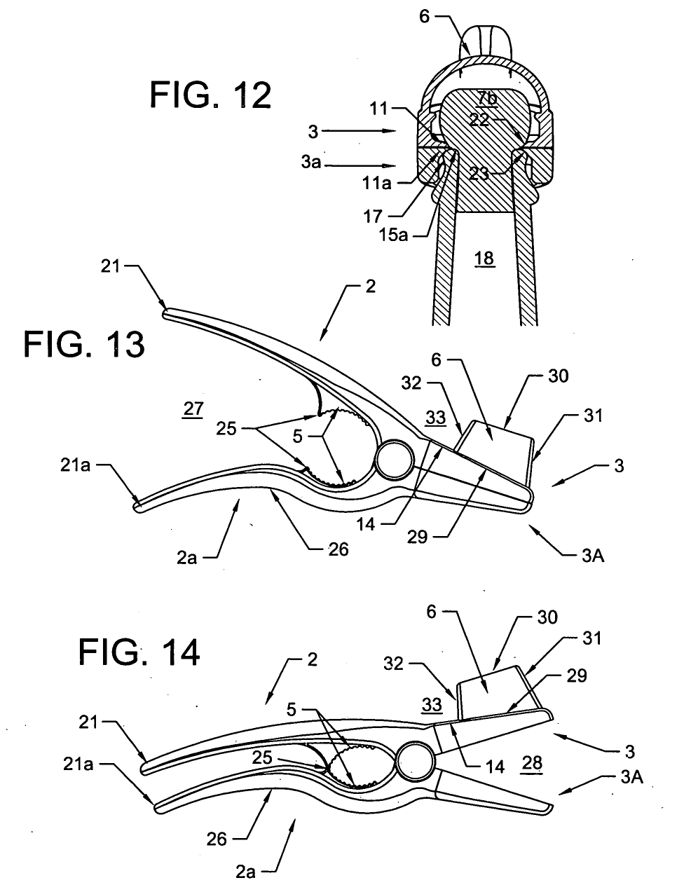

FIGS. 10 & 11 illustrate several improvements to the lower jaw 3a. The jaw's ridges 14a are significantly strengthened by incorporating a taper 20 from tip to base as viewed most clearly in FIG. 11. Tapered ridges 20 also assist in guiding the insertion of the opener around the bottle's shoulder 19 or bottle's lip 17. The anchoring means of blade 11a has been enhanced by introducing a pair of opposing curvatures 13a within the primary generally “U” shaped recess 10a brought forth in prior art. When the pair of curvatures 13a are viewed together as seen in FIG. 11, they form a primarily circular slot 16a, thereby encouraging the opener to become properly positioned about a bottle's shoulder 19 as illustrated in FIGS. 2 & 2a. Again referring to both FIGS. 10 & 11, by adding downwardly facing chamfers 24 to blade 11a at curvatures 13a, the positioning of the opener for removal of a plastic stopper 7a is enhanced. By contouring chamfers 24 to that of the typical bottle's shoulder 19, a tighter fit under plastic stopper 7a is made possible when the opener is positioned as shown in FIG. 2. Furthermore, anchoring of the lower jaw 3a has been improved when blade 11a is positioned about the bottle 18 as shown in FIGS. 3 & 3a because of the increased contact with bottle lip 17 made possible by the conforming shape of the pair of curvatures 13a. As seen in FIGS. 10 & 11 a secondary generally circular recess 12a is shown at the base of primary recess 10a, and while recess 12a was disclose in prior art, it has been made significantly more effective by introducing a downwardly facing chamfer 23 that generally conforms to the bottle's lip 18 when positioned as shown in FIGS. 4 & 4a. By adding chamfer 22 to secondary slot 12 in upper jaw 3 shown in FIG. 6, and by adding a reversed corresponding chamfer 23 to secondary slot 12a in the lower jaw 3a shown in FIGS. 10 & 11, the opener can be inserted between cork stopper 7b and bottle lip 17 without first having to partially dislodge the stopper from the bottle as required in the configuration claimed in prior art. The means to accomplish the placement of the opener shown in FIG. 4 as previously described can best be visualized by referring to FIG. 12 that illustrates the manner in which the upper and lower blades 11 & 11a form a tapered edge that is defined by opposing chamfers 22 and 23 within slots 12 and 12a.

FIGS. 13 and 14 illustrate several improvements in the pair of handles 2 and 2a over prior art. Experience reveals that with the wishbone handle configuration previously disclosed, the handles have an undesirable tendency to cross at their ends 21 & 21a when fully squeezed if made from a material having even a slight degree of flexibility as with most plastics. By reshaping the lower handle 2a so that its end 21a is primarily parallel to upper handle's end 21, the tendency for them to cross is greatly minimized. Furthermore, by including a stop means 25 between handles 2 & 2a, their ends 21 & 21a are prevented from making contact with one another when fully squeezed. This improvement not only prevents the squeezed handles 2 & 2a from crossing but eliminates the possibility of the user's palm from being pinched from handles that touch. By incorporating the stop means 25 as part of the stopper gripping means 5, the stop means 25 which would otherwise be an unattractive element becomes essentially hidden. Additionally, the lower handle 2a incorporates an upward curvature 26 thereby approximating a shallow “S” shape. This embodiment effectively reduces the maximum handle separation 27 in the relaxed position at the location where the opener is gripped, as seen in FIG. 13; at also improves the grasping of the handles for users with smaller hands without sacrificing the maximum possible angular separation 28 of jaws 3 and 3a available with the prior configuration, as seen in FIG. 14. Additional benefits are gained by reshaping the stopper retaining member 6. As can be seen in both orthographic FIGS. 13 & 14, the stopper retaining member 6 is in the form of a hood, and while the configuration was previously disclosed, the hood has been improved by the inclusion of front and rear tapers 31 & 32 making the hood 6 wider at its base 29 than at its apex 30. The front taper 31 increases the user's view of stopper 7 while positioning the opener. The rear taper 32 expands the effective space 33 for the user's thumb to be inserted under the stopper retaining member 6 for pushing the extracted stopper 7 out of the opener. Additionally, the rear taper 32 provides reinforcement to the upper jaw 3 by permitting the extension of the base 29 further towards the rear of the upper ridge 14 than would otherwise be possible.

1. An extractor for extracting a generally mushroom shaped stopper from the neck of a sparkling beverage bottle, there being an upwardly presented shoulder on said neck and at the top of said neck includes a lip concealed by said stopper, there being a downwardly presented and openly accessible rim on said stopper, and said extractor comprising a pair of levers which are pivotally interconnected, each lever defining a handle at one end thereof and a bifurcated jaw having a recess at the opposite end thereof, wherein one jaw is located above the other and each of said jaws is adapted to partially encircle the bottle's neck, such that the lower jaw is adapted to make contact with said upwardly presented shoulder and the upper jaw is adapted to make contact with said downwardly presented rim, so that a squeezing together of said pair of handles results in the separation of said jaws thereby urging said lower jaw against said upwardly presented shoulder and urging said upper jaw against said downwardly presented rim, and with leveraged force sufficient to lift said stopper relative to said neck, wherein said recess of said upper jaw is formed by a material with some degree of flexibility enabling said recess to momentarily splay and slide over said lip wherein the width of said recess in its relaxed shape is less than the diameter of said lip.

2. The device as in claim 1, wherein said recess within said upper jaw gradually narrows in width towards its interior so that said width at its narrowest point is less than the diameter of said neck where said upper jaw engages with said downwardly presented shoulder, wherein adjacent to said narrowest point and further within the interior of said recess, said recess abruptly widens where its opposing edges are formed into opposing curvatures that generally conform to the diameter of said shoulder where said upper jaw engages said downwardly presented shoulder, wherein said flexibility of said recess provides means for said recess to momentarily splay thereby enabling said upper recess at said narrowest point to slide around said shoulder thereby providing means to anchor said upper jaw on said shoulder.

3. The device as in claim 1, wherein said opposing curvatures are elongated by splitting each of said curvature into two curvatures where the radii of said split curvatures are generally equal and separated from one another, thereby permitting said recess to slide over said lip having a radius greater than any of said curvatures.

4. The device as in claim 2, wherein said flexible recess generates a tactile snap informing the user that the extractor has been properly seated.

5. An extractor for extracting a generally mushroom shaped stopper from the neck of a sparkling beverage bottle, there being an upwardly presented shoulder on said neck and at the top of said neck includes a lip concealed by said stopper, there being a downwardly presented and openly accessible rim on said stopper, and said extractor comprising a pair of levers which are pivotally interconnected, each lever defining a handle at one end thereof and a bifurcated jaw having a recess at the opposite end thereof, wherein one jaw is located above the other and each of said jaws is adapted to partially encircle the bottle's neck, such that the lower jaw is adapted to make contact with said upwardly presented shoulder and the upper jaw is adapted to make contact with said downwardly presented rim, so that a squeezing together of said pair of handles results in the separation of saidjaws thereby urging said lower jaw against said upwardly presented shoulder and urging said upper jaw against said downwardly presented rim, and with leveraged force sufficient to lift said stopper relative to said neck, wherein each of opposing edges of said recess within said lower jaw form a curvature so that said curvatures are themselves opposing one another and generally conform to the diameter of said upwardly presented shoulder.

6. The device as in claim 5, wherein the edge defining said opposing curvatures includes a downwardly facing bevel generally conforming to the slope of said upwardly presented shoulder.

7. The device as in claim 5, wherein said flexibility of said recess provides means for said recess to momentarily splay thereby enabling said lower recess at said narrowest point to slide around said shoulder thereby providing means to anchor said lower jaw on said shoulder.

8. An extractor for extracting a generally mushroom shaped stopper from the neck of a sparkling beverage bottle, at the top of said neck there being a lip with an upwardly presented shoulder not concealed by said stopper, there being a downwardly presented and openly accessible shoulder on said stopper, and said extractor comprising a pair of levers which are pivotally interconnected, each lever defining a handle at one end thereof and a bifurcated jaw having a recess at the opposite end thereof, wherein one jaw is located above the other, and each of said jaws is adapted to partially encircle the narrowest exposed diameter of said stopper's downwardly facing shoulder, such that the lower jaw is adapted to make contact with said upwardly presented shoulder of said lip, and the upper jaw is adapted to make contact with said downwardly presented shoulder of said stopper, so that a squeezing together of said pair of handles results in the separation of said jaws, urging said lower jaw against said upwardly presented shoulder of said lip and urging said upper jaw against said downwardly presented shoulder, and with leveraged force sufficient to lift said stopper relative to said lip, the improvement comprising:
said recesses of said upper and lower jaws are defined primarily by aligned and opposing circular edges, wherein said opposing circular edges of said upper jaw have an upwardly facing bevel and said opposing circular edges of said lower jaw have a downwardly facing bevel, wherein said upper and lower beveled edges oppose one another thereby enabling said pair of upper and lower jaws to partially encircle the base of said downwardly presented shoulder of said stopper, with said lower jaw accessing said upwardly facing shoulder of said lip thereby providing means to engage said stopper without said stopper being partially dislodged from said bottle.

9. A device as in claim 8, wherein the arc of said circular edge defining said upper recess extends slightly past 180°, thereby providing means to generate a locking means when said upper jaw is applied to said stopper.

10. An extractor for extracting a generally mushroom shaped stopper from the neck of a sparkling beverage bottle, there being an upwardly presented shoulder on said neck and a lip at the top of said neck, there being a downwardly presented and openly accessible rim or shoulder on said stopper, and said extractor comprising a pair of levers which are pivotally interconnected, each lever defining a handle at one end thereof and a bifurcated jaw having both primary and secondary recesses at the opposite end thereof, wherein said jaws are located above the other, such that said primary recess in the lower jaw is adapted to make contact with said upwardly presented shoulder of said bottle and said secondary recess in the lower jaw is adapted to make contact with said lip, and said primary recess within said upper jaw is adapted to make contact with said downwardly presented rim of said stopper and said secondary recess within said upper jaw is adapted to make contact with said downwardly presented shoulder of said stopper, so that squeezing together said pair of handles results in the separation of said jaws, urging said lower jaw against said upwardly presented shoulder or said lip of said bottle, and urging said upper jaw against said downwardly presented shoulder or said rim of said bottle, and with leveraged force sufficient to lift said stopper relative to said bottle, wherein said primary recess of said upper jaw is formed by a material with some degree of flexibility enabling said recess to momentarily splay and slide over said lip wherein the width of said primary recess in its relaxed shape is less than the diameter of said lip.

11. An extractor for extracting a generally mushroom shaped stopper from the neck of a sparkling beverage bottle, there being an upwardly presented shoulder on said neck and a lip at the top of said neck, there being a downwardly presented and openly accessible rim or shoulder on said stopper, and said extractor comprising a pair of levers which are pivotally interconnected, each lever defining a handle at one end thereof and a bifurcated jaw having both a recess at the opposite end thereof, wherein one jaw is located above the other, such that said recess in said lower jaw is adapted to make contact with said upwardly presented shoulder or lip, and said recess within the said upper jaw is adapted to make contact with said downwardly presented shoulder or rim of said stopper, so that squeezing together said pair of handles results in the separation of said jaws, urging said lower jaw against said upwardly presented shoulder or said lip of said bottle, and urging said upper jaw against said downwardly presented shoulder or rim of said stopper, and with leveraged force sufficient to lift said stopper relative to said bottle, comprising stopper retaining means containing a stopper deflecting means positioned and beveled in such a manner as to deflect said released stopper towards the interior of stopper retaining means.

12. An extractor for extracting a generally mushroom shaped stopper from the neck of a sparkling beverage bottle, there being an upwardly presented shoulder on said neck and a lip at the top of said neck, there being a downwardly presented and openly accessible rim or shoulder on said stopper, and said extractor comprising a pair of levers which are pivotally interconnected, each lever defining a handle at one end thereof and a bifurcated jaw having both a recess at the opposite end thereof, wherein one jaw is located above the other, such that said recess in said lower jaw is adapted to make contact with said upwardly presented shoulder or lip, and said recess within the said upper jaw is adapted to make contact with said downwardly presented shoulder or rim of said stopper, so that squeezing together said pair of handles results in the separation of said jaws, urging said lower jaw against said upwardly presented shoulder or said lip of said bottle, and urging said upper jaw against said downwardly presented shoulder or rim of said stopper, and with leveraged force sufficient to lift said stopper relative to said bottle, containing within the interior of said upper jaw, a pair of generally parallel rails placed on each side of said recess and generally parallel to the base of said upper jaw with a defined spacing between said rail providing means to restrain vertical motion of said stopper without restraining horizontal motion of said stopper.

13. An extractor for extracting a generally mushroom shaped stopper from the neck of a sparkling beverage bottle, there being an upwardly presented shoulder on said neck and a lip at the top of said neck, there being a downwardly presented and openly accessible rim or shoulder on said stopper, and said extractor comprising a pair of levers which are pivotally interconnected, each lever defining a handle at one end thereof and a bifurcated jaw having both a recess at the opposite end thereof, wherein one jaw is located above the other, such that said recess in said lower jaw is adapted to make contact with said upwardly presented shoulder or lip, and said recess within the said upper jaw is adapted to make contact with said downwardly presented shoulder or rim of said stopper, so that squeezing together said pair of handles results in the separation of said jaws, urging said lower jaw against said upwardly presented shoulder or said lip of said bottle, and urging said upper jaw against said downwardly presented shoulder or rim of said stopper, and with leveraged force sufficient to lift said stopper relative to said bottle, comprising rib means along the lower perimeter of said lower jaw where said rib means is tapered from the entrance of said recess to the rear of said jaw where said rib is at its widest.

14. An extractor for extracting a generally mushroom shaped stopper from the neck of a sparkling beverage bottle, there being an upwardly presented shoulder on said neck and a lip at the top of said neck, there being a downwardly presented and openly accessible rim or shoulder on said stopper, and said extractor comprising a pair of levers which are pivotally interconnected, each lever defining a handle at one end thereof and a bifurcated jaw having both a recess at the opposite end thereof, wherein one jaw is located above the other, such that said recess in said lower jaw is adapted to make contact with said upwardly presented shoulder or lip, and said recess within the said upperjaw is adapted to make contact with said downwardly presented shoulder or rim of said stopper, so that squeezing together said pair of handles results in the separation of said jaws, urging said lower jaw against said upwardly presented shoulder or said lip of said bottle, and urging said upperjaw against said downwardly presented shoulder or rim of said stopper, and with leveraged force sufficient to lift said stopper relative to said bottle, comprising stopper retaining means generally shaped into an inverted U-shaped hood having opposite end affixed to each side of said upper jaw, wherein the front and rear edges of said hood are tapered inward so that the length of said hood at its base is greater than at its apex.

15. An extractor for extracting a generally mushroom shaped stopper from the neck of a sparkling beverage bottle, there being an upwardly presented shoulder on said neck and a lip at the top of said neck, there being a downwardly presented and openly accessible rim or shoulder on said stopper, and said extractor comprising a pair of levers which are pivotally interconnected, each lever defining a handle at one end thereof and a bifurcated jaw having both a recess at the opposite end thereof, wherein one jaw is located above the other, such that said recess in said lower jaw is adapted to make contact with said upwardly presented shoulder or lip, and said recess within the said upper jaw is adapted to make contact with said downwardly presented shoulder or rim of said stopper, so that squeezing together said pair of handles results in the separation of said jaws, urging said lower jaw against said upwardly presented shoulder or said lip of said bottle, and urging said upper jaw against said downwardly presented shoulder or rim of said stopper, and with leveraged force sufficient to lift said stopper relative to said bottle, comprising said handle of said lower lever the end of which is primarily parallel to said upper handle, thereby forming a generally shallow “S” configuration.

16. The device as in claim 15, wherein said upper and lower handles contain within their interior a stop means thereby preventing the ends of said handles from making contact with one another when fully squeezed.

17. The device as in claim 15, wherein said pair of handles contains grip means for gripping and twisting the had of said stopper.

18. The device as in claim 17, wherein said grip means incorporates a stop means thereby preventing the ends of said handles from making contact with one another when fully squeezed.
